(19) United States
(12) Patent Application Publication
(10) Pub. No.: US 2014/0360861 A1
(43) Pub. Date: Dec. 11, 2014

(54) CATALYSIS CONTROLLED BY INTERFACIAL ELECTRIC FIELDS

(71) Applicants: Matthew W. Kanan, Palo Alto, CA (US); Eugene Beh, Stanford, CA (US); Craig Gorin, Stanford, CA (US)

(72) Inventors: Matthew W. Kanan, Palo Alto, CA (US); Eugene Beh, Stanford, CA (US); Craig Gorin, Stanford, CA (US)

(73) Assignee: The Board of Trustees of the Leland Stanford Junior University, Palo Alto, CA (US)

(21) Appl. No.: 14/240,723

(22) PCT Filed: Aug. 23, 2012
(86) PCT No.: PCT/US2012/052142

§ 371 Date: May 30, 2014

Related U.S. Application Data
(60) Provisional application No. 61/527,433, filed on Aug. 25, 2011.

(51) Int. Cl. B01J 19/08

(52) U.S. Cl. CPC B01J 19/088; B01J 2219/0809
USPC 204/165; 422/186.21

(57) ABSTRACT

A method for controlling selectivity or turnover frequency of a catalyst is provided. The catalyst is provided between a first electrode and a second electrode spaced apart from the first electrode, wherein the first electrode has an insulating layer on a first side of the first electrode and the second electrode has an insulating layer on a first side of the second electrode wherein where the first side of the first electrode and the first side of the second electrode are between the first electrode and second electrode. A fluid solution that contains a salt electrolyte and a substrate for a catalytic reaction is provided between the electrodes. A voltage is provided between the first electrode and second electrode.

### CROSS REFERENCE TO RELATED APPLICATIONS

This application claims priority under 35 U.S.C. §119 from U.S. Provisional Patent Application No. 61/527,433, filed Aug. 25, 2011, entitled MOLECULAR AND SOLID-STATE CATALYSTS CONTROLLED BY INTERFACIAL ELECTRIC FIELDS, which is incorporated herein by reference for all purposes.

### BACKGROUND OF THE INVENTION

This invention relates generally to catalysis. More specifically, the invention relates to controlling selectivity of activity of a catalytic reaction.

### SUMMARY OF THE INVENTION

In accordance with the invention, a method for controlling selectivity or turnover frequency of a catalyst is provided. The catalyst is provided between a first electrode and a second electrode spaced apart from the first electrode, wherein the first electrode has an insulating layer on a first side of the first electrode and the second electrode has an insulating layer on a first side of the second electrode wherein where the first side of the first electrode and the first side of the second electrode are between the first electrode and second electrode. A fluid solution that contains a salt electrolyte and a substrate for a catalytic reaction is provided between the electrodes. A voltage is provided between the first electrode and second electrode.

In another manifestation of the invention an apparatus for controlling selectivity or turnover frequency of a catalyst is provided. A channel is provided. A first electrode is provided on a first side of or within the channel A second electrode is provided spaced apart from the first electrode on a second side of or within the channel. A first insulating layer is provided on a first side of the first electrode between the first electrode and the channel. A second insulating layer is provided on a first side of the second electrode between the second electrode and the channel, wherein where the first side of the first electrode and the first side of the second electrode are between the first electrode and second electrode. A catalyst is attached to the first insulating layer. A fluid delivery system that flows a fluid solution that contains a salt electrolyte and a substrate for a catalytic reaction between the electrodes through the channel A voltage source is electrically connected between the first electrode and second electrode.

The invention and objects and features thereof will be more readily apparent from the following detailed description and appended claims when taken with the drawings.

### BRIEF DESCRIPTION OF THE DRAWINGS

FIGS. 1A-B is schematic view of an embodiment of the invention, where 0 volts is applied.

FIGS. 2A-B is schematic view of an embodiment of the invention, where a positive voltage is applied.

FIGS. 3A-B is schematic view of an embodiment of the invention, where a negative voltage is applied.

FIG. 4A is a schematic expanded view of the Al₂O₃ electrolyte interface at positive V, where the charge density on the underlying Si (σ) is balanced by electrolyte ions.

FIG. 4B is a graph of chronocoulometric measurements of σ at selected voltages in the parallel plate cell with 0.5 mM TBAPF₆ in CH₃CN (squares) and CH₂Cl₂ (circles).

FIG. 5A illustrates the chemical reaction in an embodiment of the invention.

FIG. 5B is a graph of product ratios as a function of voltage for experiments in CH₃CN.

FIG. 5C is a graph of product ratios as a function of voltage for experiments in CH₂Cl₂.

FIG. 6A is a schematic view of a chemical reaction in another embodiment of the invention.

FIG. 6B is a schematic illustration of how a catalyst is attached to the Al₂O₃.

FIG. 7 is a schematic view of a chemical reaction in another embodiment of the invention.

FIG. 8 is a high level flow chart of an embodiment of the invention.

FIG. 9 is a side view of an embodiment of the invention.

FIG. 10 is a cross-sectional view of the embodiment of the invention shown in FIG. 9 along cut-lines 10.

### DETAILED DESCRIPTION OF ILLUSTRATED EMBODIMENTS

Controlling selectivity is arguably the principal challenge facing the development of efficient chemical syntheses. For irreversible reactions, selectivity is determined by the relative magnitudes of competing activation barriers on a reaction's potential energy surface. Because this surface is determined by the chemical structures of the reaction components, efforts to control selectivity have necessitated making changes to one or more of these components. Identifying structural features that induce selectivity can be extremely challenging because of the complexities of molecular structure-activity relationships. In principle, however, an externally applied electric field could also be used to control selectivity through field-dipole interactions. This concept is particularly appealing because all unique molecules and transition states have unique interactions with an electric field determined by their structure-specific charge distributions.

Previous experimental studies have demonstrated that static electric fields affect the rates of electron transfer reactions in enzymatic and synthetic systems and a recent study has provided spectroscopic evidence for an interfacial electric field effect on the tautomerization equilibrium of an electrode-attached synthetic molecule. Large electric fields (1-10 V/nm) within zeolite cavities have been exploited for visible-light photooxidations of simple hydrocarbons with O₂. Naturally occurring electric fields in enzyme active sites have also been implicated as major contributors to enzymatic catalysis. Furthermore, density functional theory studies of reactions in uniform electric fields have concluded that selectivity is highly sensitive to strong fields.

Researchers have demonstrated that electrochemical changes of conductive catalysts can alter the rates of non-electrochemical reactions including gas phase oxidations of simple hydrocarbons with O₂, oxidation of H₂ with O₂ and alkene isomerizations. This electrochemical promotion of catalysis (EPOC) results from voltage-induced ion migration onto the conductive catalyst surface that changes the work function or available active sites. In contrast, we believe that the local electric field of a catalytic reaction could be controlled without effecting electrochemical changes to the catalyst by localizing it to a suitably designed electrode-electrolyte interface. An embodiment of the invention provides an externally-controlled double layer charge density that changes the selectivity of epoxide rearrangement reactions catalyzed by an insulating Lewis acidic metal oxide. Our results are consistent with a field-dipole origin of the selectivity changes and provide a general experimental method to evaluate electric field effects on catalytic reactions.

### Embodiment with Metal Oxide-Catalyzed Epoxide Rearrangement

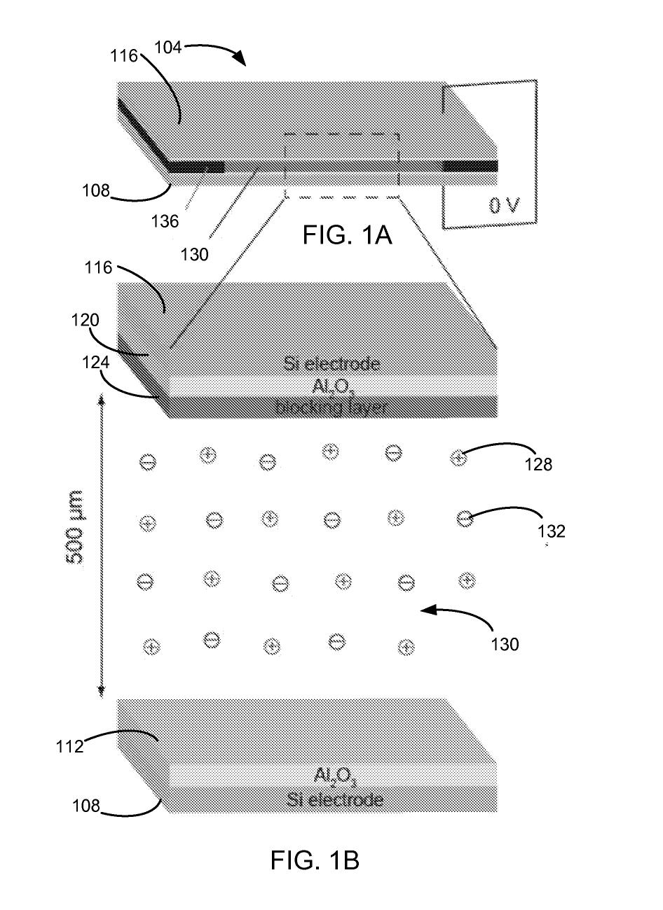

An embodiment of the invention provides a reaction vessel (“parallel plate cell”) that enables the electrostatic environment of a solution-exposed metal oxide to be controlled with a voltage source, as shown in FIG. 1A. FIG. 1A is a schematic view of a parallel plate cell 104 used in an embodiment of the invention. FIG. 1B is an enlarged cross-sectional view of a portion of the parallel plate cell 104, as indicated by the dashed box. The parallel plate cell 104 comprises a first electrode 108, which in this embodiment is silicon, a first insulating layer 112, which in this embodiment is aluminum oxide (Al₂O₃) over a surface of the first electrode 108, a second electrode 116, which in this embodiment is silicon, is spaced apart from the first electrode 108. A second insulating layer 120, which in this embodiment is Al₂O₃, is over a surface of the second electrode 116. A blocking layer 124 is over a surface of the second insulating layer 120. The first insulating layer 112, the second insulating layer 120, and the blocking layer 124 are between the first electrode 108 and the second electrode 116. A gasket 136 is placed between the first insulating layer 112 and the blocking layer 124 forming a chamber in which an electrolyte 130 with positive ions 128 and negative ions 132 is placed.

In FIG. 1A, 0V is applied between the first electrode 108 and the second electrode 116. Since a voltage is not applied, the positive ions 128 and negative ions 132 are randomly distributed.

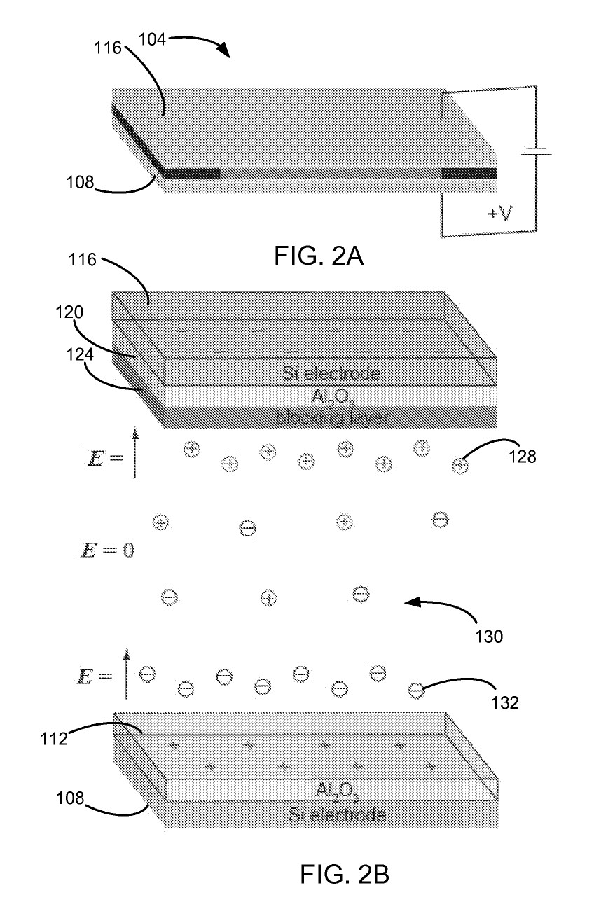

FIG. 2A is a schematic view of the parallel plate cell 104 used in the embodiment of the invention, shown in FIG. 1A, where a positive voltage is applied. FIG. 2B is an enlarged cross-sectional view of a portion of the parallel plate cell 104, shown in FIG. 2A. Since a positive voltage is applied, the negative ions 132 are attracted to the first electrode 108 and the positive ions 128 are attracted to the second electrode 116. The electric fields are shown, which indicate that significant V-dependent electric fields are present only at the interfaces. The second insulating layer 120 is blocked with a blocking layer 124 of alkylphosphonic acid monolayer to confine catalysis to the first insulating layer 112.

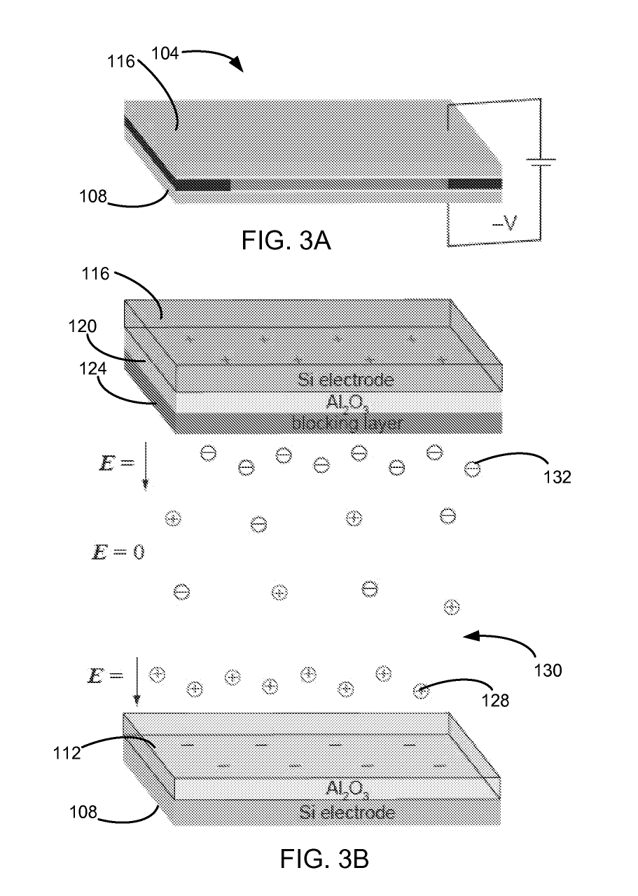

FIG. 3A is a schematic view of the parallel plate cell 104 used in the embodiment of the invention, shown in FIG. 1A, where a negative voltage is applied. FIG. 3B is an enlarged cross-sectional view of a portion of the parallel plate cell 104, shown in FIG. 3A. Since a negative voltage is applied, the positive ions 128 are attracted to the first electrode 108 and the negative ions 132 are attracted to the second electrode 116. The electric fields are shown, which indicate that significant V-dependent electric fields are present only at the interfaces. The second insulating layer 120 is blocked with a blocking layer 124 of alkylphosphonic acid monolayer to confine catalysis to the first insulating layer 112.

In a specific example of this embodiment, the parallel plate cell employs two heavily p-doped Si electrodes forming the first and second electrodes 108, 116. Each electrode is coated on one side with a thin (45 Å) layer of Al₂O₃ that is deposited by using atomic layer deposition (ALD) forming the first and second insulating layers 112, 120. The Al₂O₃ insulating layer 112 of one of the first electrode 108 is used as the catalytically active oxide in the parallel plate cell experiments (the “catalyst electrode”); the Al₂O₃ insulating layer 120 of the second electrode 116 is coated with an alkylphosphonic acid monolayer, forming the blocking layer 124, to block reactivity at this surface (“counter electrode”). In an assembled parallel plate cell, the two electrodes are separated by a 500 μm thick perfluorinated gasket 136 with a rectangular opening in the center; an electrolyte solution containing the substrate for a reaction occupies the volume between the two electrodes determined by the dimensions of the gasket. Application of a voltage between the two electrodes generates electrochemical double layers at each interface and places the exposed Al₂O₃ layer on the catalyst electrode in an interfacial electric field.

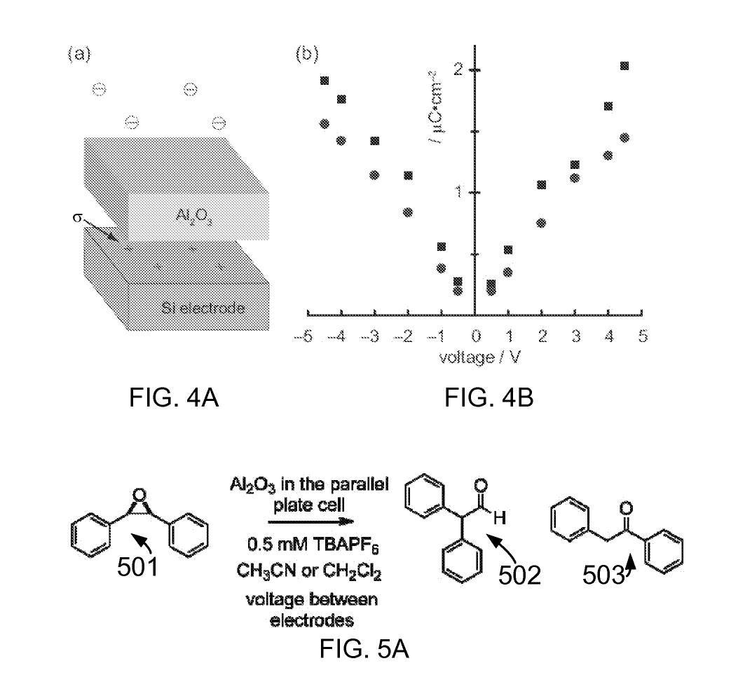

The strength of the interfacial electric field at the surface of the exposed Al₂O₃ layer depends on the extent of double layer charging—i.e. the charge density on the Si electrode that is balanced by electrolyte ions at the oxide-electrolyte interface. To measure this charge density as a function of the applied voltage (V), we performed double step chronocoulometry with fully assembled cells. The cells were comprised of 45 Å of Al₂O₃ on the catalyst electrode and 45 Å of Al₂O₃ coated with a monolayer of octylphosphonic acid on the counter electrode. In a CH₃CN or CH₂Cl₂ solution containing 0.5 mM tetrabutylammonium hexafluorophosphate (TBAPF₆), the charge vs. time curves exhibit a rapid (<50 ms) rise that is characteristic of double layer charging. A similar discharge is observed upon stepping back to 0 V. The amount of double layer charging increases approximately linearly with V, as shown in FIGS. 4A and B, where FIG. 4A is a schematic expanded view of the Al₂O₃ electrolyte interface at positive V, where the charge density on the underlying Si (σ) is balanced by electrolyte ions. FIG. 4B is a graph of chronocoulometric measurements of σ at selected voltages in the parallel plate cell with 0.5 mM TBAPF₆ in CH₃CN (squares) and CH₂Cl₂ (circles). Data is shown for a cell with 45 Å of Al₂O₃ on each electrode and an octylphosphonic acid monolayer on the counter electrode. For |V|>2 V, double layer charging in excess of 1 μC/cm² is observed. These values are comparable to double layer charge densities measured for metal electrodes in contact with dilute electrolytes in CH₃CN. The difference in charge densities measured in CH₂Cl₂ and CH₃CN likely reflects the difference in polarity of these solvents. The chronocoulometric measurements are also consistent with the double layer capacitance values obtained by electrochemical impedance spectroscopy measurements.

In a simplified model, a charge density of 1 μC/cm² on the underlying Si electrode balanced by an oppositely charged plane of ions in the double layer generates a field of 1.1 V/nm at the oxide surface. The actual field at the oxide surface with 1 μC/cm² on the underlying Si deviates from this value depending on the diffusivity of the double layer, the proportion of ions that are specifically adsorbed and the polarization of the reaction medium in the vicinity of the surface. The field also fluctuates due to the mobility of ions in the double layer. The charge densities measured by chronocoulometry therefore indicate that voltage-dependent field strengths on the order of 1 V/nm are accessible at |V|>3 V in the parallel plate cell. Indirect measurements of field strengths at other electrode-electrolyte interfaces have yielded similar values. Field strengths of this magnitude are sufficient to significantly affect the selectivity of a reaction. For example, if two competing transition states arise from a common intermediate, the field effect on selectivity is determined solely by the difference between its effects on the transition states. If the charge distributions of the transition states in the presence of the electric field E are approximated as dipole moments μ₁ and μ₂, the energetic differentiation induced by E is given by ΔU=E·Δμ, where Δμ=μ₁−μ₂. According to this model, a 1 V/nm electric field would induce a ˜10-fold change in selectivity at 300 K if the projection of Δμ along the field axis were 2.8 D (E·Δμ=1.4 kcal/mol).

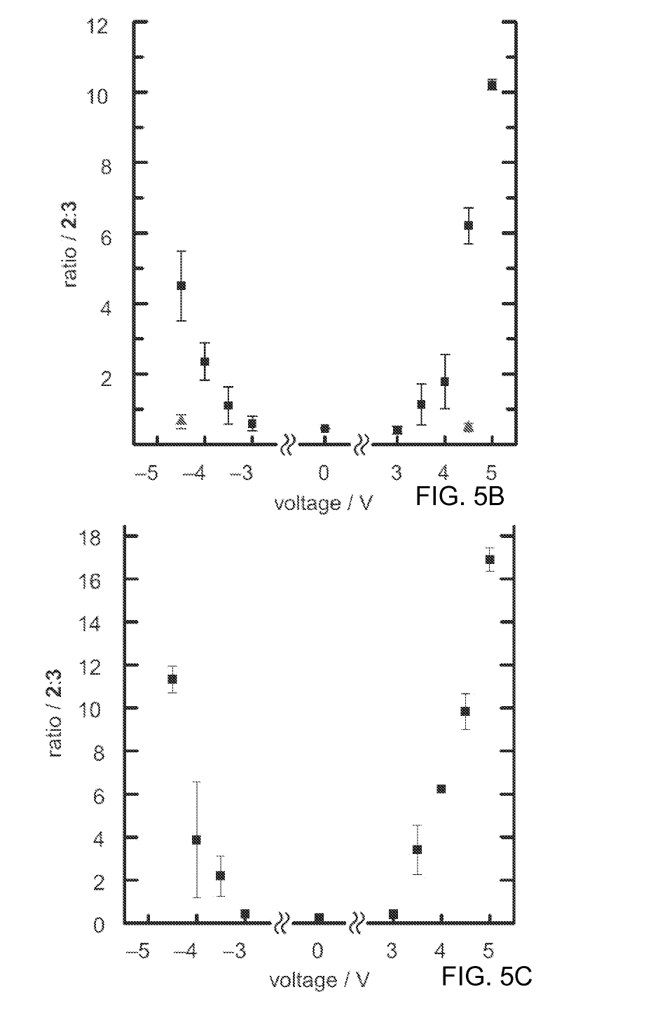

Lewis acidic metal oxides including Al₂O₃ are known to catalyze numerous organic reactions including epoxide rearrangements. To study electric field effects on Al₂O₃ catalysis, we selected the rearrangement of cis-stilbene oxide 501 to diphenylacetaldehyde 502 and diphenylethanone 503 as a model reaction, as shown in FIG. 5A, which illustrates the chemical reaction. Parallel plate cell reactions were performed in cells with 45 Å of Al₂O₃ on the catalyst electrode and 45 Å of Al₂O₃ coated with an octylphosphonic acid layer on the counter electrode. The electrolyte solution consisted of 5 mM cis-stilbene oxide 501 and 0.5 mM TBAPF₆ in either CH₃CN or CH₂Cl₂. After assembly of the cell, the electrodes were either connected by short circuit (0 V) or a constant voltage was applied across the two electrodes by using a sourcemeter. Parallel plate cell reactions were allowed to proceed for 16 h. At the conclusion of each experiment, the cell was disassembled and the conversion and product ratio were determined by using high-pressure liquid chromatography (HPLC). For V≦5 V, a leakage current of 2-10 nA/cm² is observed over the course of the experiment, corresponding to a total moles of charge passed that is ˜0.5-2.5% of the total moles of cis-stilbene oxide 501 in the cell. Voltages>5 V lead to dielectric breakdown and increasing currents over time.

The product ratio for the rearrangement of cis-stilbene oxide 501 catalyzed by an Al₂O₃ layer in the parallel plate cell exhibits strong dependence on V, as shown in FIG. 5B, which is a graph of product ratios as a function of voltage for experiments in CH₃CN and in FIG. 5C, which is a graph of product ratios as a function of voltage for experiments in CCH₂Cl₂. Squares correspond to experiments with octylphosphonic acid on the counter electrode. Triangles correspond to experiments with octadecylphosphonic acid on the counter electrode. In all cases, the reaction proceeds cleanly such that the products diphenylacetaldehyde 502 and diphenylethanone 503 and remaining starting material cis-stilbene oxide 501 account for nearly all of the material detected by HPLC. At 0 V in CH₃CN, 5% of cis-stilbene oxide 501 is converted to diphenylacetaldehyde 502 and diphenylethanone 503 in a 1:2.2 ratio, similar to the ratio that is observed for the reaction catalyzed by Al₂O₃ powder in the same solution. For |V|≦3 V, negligible changes in the selectivity are observed. However, for V>3 V, the diphenylacetaldehyde 502:diphenylethanone 503 ratio increases exponentially as V is increased and the conversions are 2-4-fold higher than at 0 V. At +5 V, the diphenylacetaldehyde 502:diphenylethanone 503 ratio is 10.2:1, representing a ˜22-fold enhancement over the ratio at 0 V. Strikingly, a similar trend is observed at negative voltages. For V<−3 V, the diphenylacetaldehyde 502:diphenylethanone 503 ratio increases exponentially as the voltage is decreased and the conversions are 2-5 fold higher than at 0 V; at −4.5 V the ratio is 4.5:1, representing a ˜10-fold enhancement over the 0 V ratio. At voltages where dielectric breakdown is observed, large quantities of additional unidentified products are observed by high performance liquid chromatography (HPLC).

The electric field strength at the surface of the exposed Al₂O₃ layer in the parallel plate cell can also be adjusted by changing the double layer capacitance of the cell. Accordingly, an electric field effect on selectivity should depend on capacitance in addition to V. An embodiment shows this in a cell in which the counter electrode was coated with an octadecylphosphonic acid layer instead of an octylphosphonic acid layer. The extended hydrocarbon chain was expected to lower the capacitance of the counter electrode interface. In 0.5 mM TBAPF₆ in CH₃CN, the double layer charge densities determined by chronocoulometry for this cell at +4.5 V and −4.5 V are 1.56 μC/cm² and 1.52 μC/cm², respectively, ˜0.5 μC/cm² lower than the corresponding values for a cell with an octylphosphonic acid-coated counter electrode. At 0 V, the diphenylacetaldehyde 502:diphenylethanone 503 ratio is the same for experiments in cells with the two different counter electrodes; however, at ±4.5 V, the diphenylacetaldehyde 502:diphenylethanone 503 ratios for a cell with an octadecylphosphonic acid-coated counter electrode are unchanged, in sharp contrast to the ˜10-fold increases observed for cells with an octylphosphonic acid layer on the counter electrode, triangles in FIG. 5B. These results indicate that selectivity changes in the parallel plate cell depend not on V by itself, but on double layer charge densities, as required for a field-dipole effect. In this case, the double layer charge density at the exposed Al₂O₃ layer and its effect on selectivity were lowered by changing the blocking layer on the counter electrode 500 μm away.

Larger V-dependent selectivity changes are observed for parallel plate cell reactions performed in 0.5 mM TBAPF₆ in CH₂Cl₂ with octylphosphonic acid on the counter electrode than in CH₃CN, as shown in FIG. 5C. At 0 V, the reaction proceeds in 4% conversion to form a 1:3.7 ratio of diphenylacetaldehyde 502:diphenylethanone 503. For |V|>3 V, the conversions are >10-fold higher and the diphenylacetaldehyde 502:diphenylethanone 503 ratios increase exponentially with voltage to reach 16.9:1 at +5 V and 11.3:1 at −4.5 V, representing ˜63-fold and ˜42-fold enhancements, respectively. The larger selectivity changes in CH₂Cl₂ may reflect a more compact electrochemical double layer, which engenders larger fields at the Al₂O₃ surface. This effect could outweigh the somewhat smaller double layer charge density in CH₂Cl₂ compared to CH₃CN, as measured by chronocoulometry.

In control experiments, very low (<1%) conversions of cis-stilbene oxide 501 are observed for reactions in parallel plate cells with octylphosphonic acid monolayers on both Al₂O₃ layers at 0 V or ±4.5 V, indicating that the reaction takes place at the Al₂O₃ surface, as expected. To determine whether voltage permanently alters the Al₂O₃ layers, catalyst electrodes that had previously been used at +4.5 V in a parallel plate cell reaction were subsequently reused in a parallel plate cell at 0 V with a fresh solution of cis-stilbene oxide 501. The conversion and selectivity with the reused electrode at 0 V matched that of a fresh catalyst electrode at 0 V, indicating that an applied voltage does not lead to an irreversible change in the Al₂O₃ layer that alters its catalytic activity. Additional control experiments ruled out the contribution of electrolytically generated H⁺ to the observed selectivity changes.

Together, the chronocoulometry, voltage-dependent selectivity data and associated control experiments are consistent with an electric field effect on the rearrangement of cis-stilbene oxide 501 catalyzed by Al₂O₃. The double layer charge density increases approximately linearly with V, generating V-dependent interfacial electric fields. While the strength of the field at the molecular level cannot be determined by the measurements described here, field strengths on the order of 1 V/nm are reasonable given the measured charge densities. Significantly higher transient electric fields may also be accessible in the vicinity of the electrolyte ions that accumulate at the interface. The largest selectivity change observed here—a factor of 63—corresponds to 2.5 kcal/mol perturbation of the difference between activation barriers leading to the two products. To account for this perturbation with a field dipole model in which the field is 1 V/nm, the difference in dipole moments between the competing activation barriers (Δμ) must be 5.1 D along the direction of the field. We hypothesize that the transition state leading irreversibly to diphenylacetaldehyde 502 has a dipole moment that is several Debye larger than the transition state leading to diphenylethanone 503 and that the reactants/transition states are readily aligned in the local field at the interface. Thus, field-dipole interactions lower the barrier to diphenylacetaldehyde 502 relative to diphenylethanone 503 to an extent that depends on the magnitude of the local field but not its direction, accounting for the symmetry of the selectivity changes at ±V. Interactions between the local field and induced dipole moments may also contribute to the selectivity changes. Additionally, unique solvent or electrolyte properties in the interfacial region when a voltage is applied such as ordering of solvent molecules and high local concentrations of electrolyte ions may contribute to the selectivity changes.

The results obtained for the reaction of cis-stilbene oxide 501 catalyzed by Al₂O₃ in the parallel plate cell are not unique to this combination of substrate and catalyst. In a preliminary examination of an alternative substrate, a 30-40-fold change in the ratio of aldehyde to ketone products is observed at ±4.5 V relative to 0 V if 2-(4-chlorophenyl)-3-phenyloxirane is used as the substrate. In addition, a 2-7-fold change in the ratio of diphenylacetaldehyde 502:diphenylethanone 503 is observed at ±4.5 V relative to 0 V if an HfO₂ layer is used as the catalyst instead of Al₂O₃.

The breakdown voltage and interfacial capacitance of the Al₂O₃-coated Si electrodes limit the maximum attainable interfacial field strength in the parallel plate cell. The use of alternative insulating layers with higher dielectric constants or alternative electrolytes such as ionic liquids may enable the application of substantially larger fields. For reactions in which E·Δμ contributes to ΔΔG^{‡}, such increases would dramatically improve the control over selectivity afforded by this approach.

Other embodiments may involve localizing other thin film, nanoparticle or molecular catalysts in interfacial fields, which enable the study of field effects across a wide spectrum of reactions. Furthermore, the design principles of the parallel plate cell may in theory be extended to flow reactors that enable field effects to be exploited on a preparative scale. Various embodiments provide field effects, which will provide a general approach towards controlling the selectivity of catalytic reactions.

### Embodiment with NHC-Au Catalysis For Sulfoxide Rearrangement

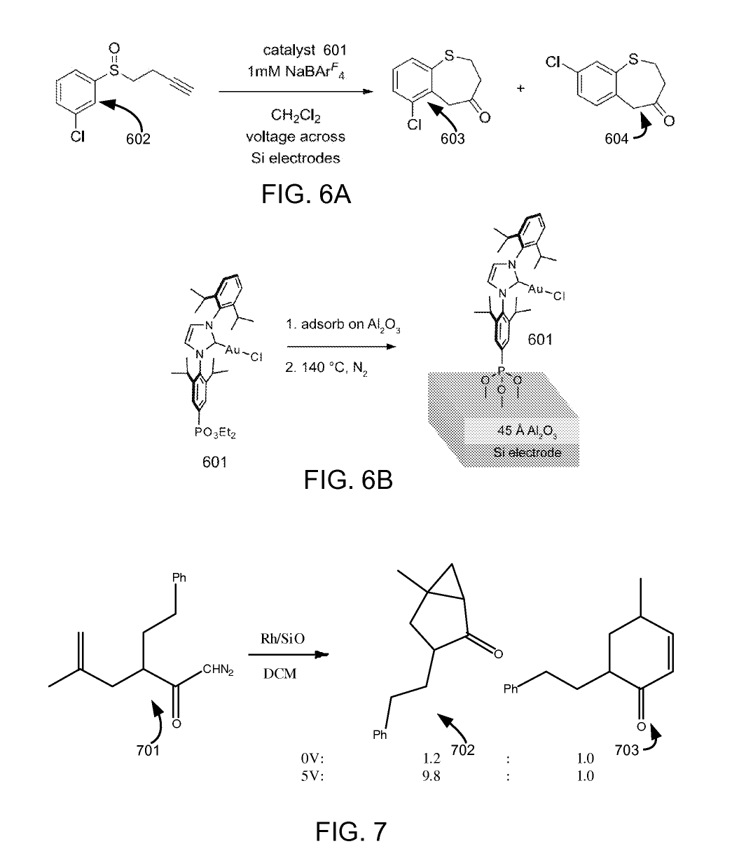

The effects of interfacial fields on the selectivity of NHC-Au catalysis were studied in a sulfoxide rearrangement reaction. FIG. 6A is a schematic view of a chemical reaction with a catalyst 601. Reactions were performed in the parallel plate cell with 1 mM sulfoxide 602 and 1 mM NaBAr^{F}₄ in CH₂Cl₂. A series of experiments were performed with cells in which complex catalyst 601 was attached to one of the Al₂O₃-coated electrodes. FIG. 6B is a schematic illustration of how the catalyst 601 is attached to the Al₂O₃. Assuming 100 pmol/cm² coverage of the complex catalyst 601 on the Al₂O₃ surface, the catalyst 601 loading is approximately 0.2 mol % for a 1 mM substrate concentration and a gasket thickness of 500 μm. After assembling the cell, the two electrodes were either shorted (0 V) or a constant voltage applied by using a sourcemeter. Reactions were allowed to proceed for 19 h, after which the parallel plate cells were disassembled and the reaction solutions analyzed by using high-performance liquid chromatography (HPLC).

Product ratios for the rearrangement reaction catalyzed by surface-attached catalyst 601 are strongly dependent on the voltage applied to the parallel plate cell. At 0 V, the reactant 602 reacts to form product 603 and product 604 in a 0.87:1.00 ratio. This ratio is very similar to the ratio obtained for the reaction performed under typical homogeneous conditions, with 2 mol % of catalyst 601 and 2 mol % NaBAr^{F}₄ in CH₂Cl₂.

Typically, dielectric breakdown occurs with the Al₂O₃-coated electrodes when |V|≧6 V and is apparent as an increasing leakage current with time as more of the insulating dielectric is eroded away. At voltages of +5 V and −5 V where dielectric breakdown does not take place, the ratio of product 603:product 604 increases to 1.78:1.00 and 1.38:1.00 respectively such that product 603 now becomes the major product. In addition, the overall conversion of reactant 602 is positively correlated with an increase in the product 603:product 604 ratio.

### Embodiment with Rhodium Nanoparticle Catalysis On Silicon Oxide For Diazoketone Rearrangement

In another embodiment the effect of electric fields on nanoparticle catalyzed reactions was studied using a rhodium nanoparticle on silicon dioxide (Rh/SiO₂) system. To prepare the catalyst, 53 Å of silica was thermally grown on a highly doped silicon substrate. These wafers were soaked for 2 hours in an aqueous solution of surfactant-stabilized rhodium nanoparticles, and dried overnight at 60° C. The surfactant was then rinsed away by sonication in water for 15 minutes. This provided a layer of rhodium particles at the electrode surface, characterized by XPS.

The Rh/SiO₂ electrode was functional for catalyzing the decomposition of diazoketone 701 into products 702 and 703, as shown in FIG. 7. The reaction was run with 5 mM substrate and 0.5 mM TBAPF₆ in dichloromethane in the parallel plate cell, with a Rh/SiO₂ wafer as the working electrode, and a clean SiO₂ wafer as the counter electrode. The product distribution was highly dependent on the applied voltage. At 0 V, the ratio of the cyclopropane 702 to the cyclohexenone 703 was 1.2±0.1:1.0. At an applied potential of 5 V, the ratio changed to 9.8±0.4:1.0.

### Embodiment With Flowing Solution

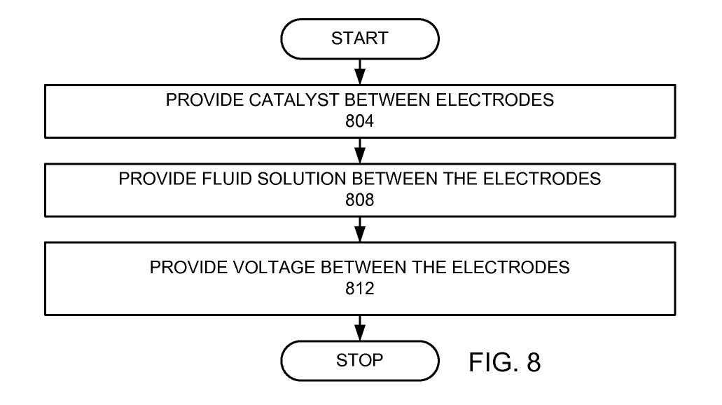

To facilitate understanding of the invention, FIG. 8 is a high level flow chart of an embodiment of the invention. In this embodiment, a catalyst is provided between a first electrode and a second electrode spaced apart from the first electrode (step 804). The first electrode has an insulating layer on a first side of the first electrode. The second electrode has an insulating layer on a first side of the second electrode, where the first side of the first electrode and the first side of the second electrode are between the first and second electrodes. A fluid solution that contains a salt electrolyte and a substrate for a catalytic reaction is provided between the first and second electrodes (step 808). A voltage is provided between the first and second electrodes (step 812).

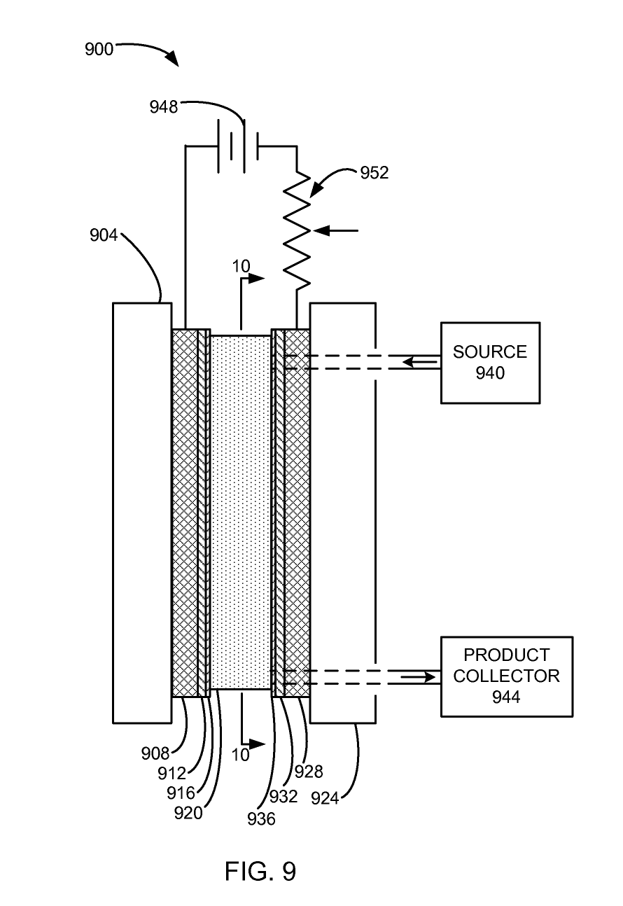

FIG. 9 is a schematic side view of an embodiment 900. The embodiment comprises a first support plate 904, which supports a first electrode 908. In this embodiment, the first support plate 904 is steel and the first electrode 908 is gold. A first insulating layer 912 of Al₂O₃ is on a first side of the first electrode 908. A catalyst 916 is attached to the first insulating layer 912. In this embodiment, Al₂O₃ also serves as the catalyst. A gasket 920 of Teflon® is placed on the insulating layer 912 and catalyst 916. On the other side of the gasket 920 is a second support plate 924 of steel, which supports a second electrode 928 of gold. A second insulating layer 932 of Al₂O₃ is on a first side of the second electrode 928. A catalyst 936 is attached to the second insulating layer 932. In this embodiment, Al₂O₃ also serves as the catalyst. The catalyst 936 attached to the second insulating layer 932 is on a side of the gasket 920 opposite the catalyst 916 attached to the first insulating layer 912.

A source 940 is in fluid connection with a chamber in the gasket 920. A product collector 944 is in fluid connection with a chamber in the gasket 920. A voltage source 948 is electrically connected between the first electrode 908 and the second electrode 928. A potentiometer 952 is electrically connected between the voltage source 948 and the second electrode 928.

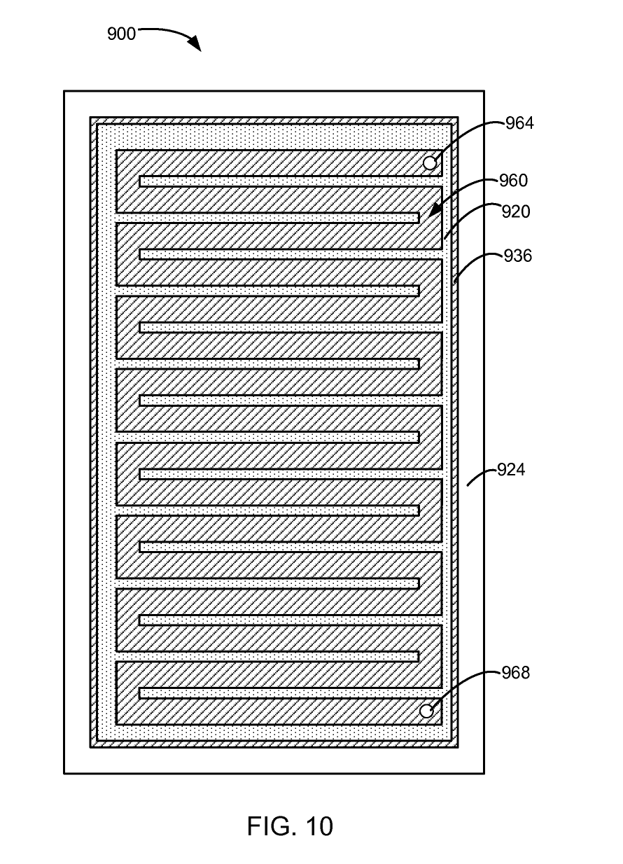

FIG. 10 is a cross-sectional view of the embodiment 900 along cut-lines 10-10. The second support plate 924 is shown under the catalyst 936 attached to the second insulating layer 932, which is placed over the second electrode 928. The gasket 920 is placed over the catalyst 936. In this example, a channel 960 is formed in the gasket 920 to expose the catalyst 936 to a chamber formed by the channel The channel 960 has a serpentine shape to increase the channel length with respect to volume. A source inlet 964 is placed at a first end of the channel 960. A product outlet 968 is placed at a second end of the channel 960.

In operation, a catalyst is provided between the electrodes (step 804). In this embodiment, the catalyst 920, 936 is Al₂O₃. In this embodiment, the catalyst is attached to the insulation on the first electrode since the insulation is the same material as the catalyst. In this embodiment, the catalyst is also attached to insulation on the second electrode, so that the catalyst is provided on opposite sides of the channel to increase the surface area of the catalyst. A fluid solution of CH₃CN or CH₂Cl₂ containing 0.5 mM tetrabutylammonium hexafluorophosphate (TBAPF₆) is flowed from the source 940 through the source inlet 964 into a first end of the channel 960 between the first electrode 908 and the second electrode 928 (step 808). A voltage of 4 volts is applied between the electrodes (step 812). The potentiometer 952 is set so that a specific voltage is applied between the electrodes to provide a specified selectivity or turnover frequency. The fluid solution is flowed through the channel 960 from the first end of the channel 960 to the second end of the channel 960, where the fluid exits the channel 960 through the product outlet 968 to the product collector 944. In the product collector 944, a process may be used to separate the products of diphenylacetaldehyde and diphenylethanone.

Although in some embodiments the attachment of the catalyst to the insulating layer is through covalent bonding, in other embodiments, the attachment of the catalyst to the insulating layer may be through other ways to localize the catalyst, such as through adsorption. In embodiments using adsorption, the attachment of the catalyst to the insulating layer is not through covalently bonding the catalyst to the insulating layer but instead the catalyst spontaneously adsorbs on the insulating layer. The catalyst may adsorb because of Van der Waals interactions, hydrogen bonding, Lewis acid-Lewis base interactions, electrostatic interactions or other non-covalent bonding interactions and the adsorption may be induced or enhanced by the application of the voltage. When adsorbed on the electrode surface, the catalyst is subjected to a similar interfacial environment that a covalently attached catalyst is subjected to.

In this embodiment, in addition to continuously flowing solution between the electrodes, there is no blocking layer so both electrodes are used for performing the catalysis. Since FIG. 5B indicates that both positive and negative voltages increase selectivity in the same manner, both electrodes may be used to provide an increased selectivity.

In other embodiments, the insulation layer has a thickness of less than 100 Å. Preferably, the insulation layer permits double layer charging of at least 1 μC/cm² before dielectric breakdown under the reaction and voltage conditions. In embodiments of the invention, most of the catalytic reaction occurs within 10 nm of the insulator. Other embodiments provide insulating layers that are able to withstand higher voltages and provide higher charge densities to provide higher fields.

In one embodiment, application of a voltage changes the turnover frequency of the catalyst, which is the number of times the catalyst completes a catalytic cycle per unit time. An effect on the turnover frequency may or may not be accompanied by an effect on the selectivity of the catalyst.

While this invention has been described in terms of several preferred embodiments, there are alterations, permutations, modifications and various substitute equivalents, which fall within the scope of this invention. It should also be noted that there are many alternative ways of implementing the methods and apparatuses of the present invention. It is therefore intended that the following appended claims be interpreted as including all such alterations, permutations, modifications, and various substitute equivalents as fall within the true spirit and scope of the present invention.

1. A method for controlling at least one of selectivity or turnover frequency of a catalyst, comprising:
providing the catalyst between a first electrode and a second electrode spaced apart from the first electrode, wherein the first electrode has an insulating layer on a first side of the first electrode and the second electrode has an insulating layer on a first side of the second electrode wherein where the first side of the first electrode and the first side of the second electrode are between the first electrode and second electrode;
providing a fluid solution that contains a salt electrolyte and a substrate for a catalytic reaction between the electrodes; and
providing a voltage between the first electrode and second electrode.

2. The method, as recited in claim 1, wherein the providing the catalyst comprises attaching the catalyst to the insulating layer on the first side of the first electrode.

3. The method, as recited in claim 2, wherein the attaching the catalyst to the insulating layer on the first side of the first electrode, comprises forming the insulating layer on the first side of the first electrode from the catalyst.

4. The method, as recited in claim 3, wherein the providing the catalyst further comprises attaching the catalyst to the insulation layer on the first side of the second electrode.

5. The method, as recited in claim 4, wherein the providing a voltage provides a specified voltage to obtain at least one of a specified selectivity or turnover frequency.

6. The method, as recited in claim 5, further comprising determining a specified voltage for obtaining the at least one of specified selectivity or turnover frequency.

7. The method, as recited in claim 6, wherein the attaching the catalyst comprises adding a catalyst to solution that spontaneously adsorbs on the insulating layer.

8. The method, as recited in claim 7 wherein catalysis occurs within 10 nm of the insulating layer on the first side of the first electrode or second electrode.

9. The method, as recited in claim 8, wherein the providing the fluid solution that contains the salt electrolyte and the substrate, comprises flowing the fluid solution between the first and second electrodes, while providing the voltage between the first electrode and the second electrode.

10. The method, as recited in claim 9, wherein the providing a voltage provides a specified voltage to obtain a specified selectivity.

11. The method, as recited in claim 10, further comprising determining a specified voltage for obtaining the specified selectivity.

12. The method, as recited in claim 11, wherein the attaching the catalyst to the insulating layer comprises bonding the catalyst to the insulating layer with covalent bonds.

13. An apparatus for controlling at least one of selectivity or turnover frequency of a catalyst, comprising:
a channel;
a first electrode on a first side of or within the channel;
a second electrode spaced apart from the first electrode on a second side of or within the channel;
a first insulating layer on a first side of the first electrode between the first electrode and the channel;
a second insulating layer on a first side of the second electrode between the second electrode and the channel, wherein where the first side of the first electrode and the first side of the second electrode are between the first electrode and second electrode;
a catalyst attached to the first insulating layer;
a fluid delivery system that flows a fluid solution that contains a salt electrolyte and a substrate for a catalytic reaction between the electrodes through the channel; and
a voltage source for providing a voltage between the first electrode and second electrode.

14. The apparatus, as recited in claim 13, wherein the catalyst attached to the first insulating layer is formed from the first insulating layer.

15. The apparatus, as recited in claim 14, further comprising catalyst attached to the second insulating layer.

16. The apparatus, as recited in claim 15, wherein the catalyst is attached by adsorption on the insulator surface.

17. The apparatus, as recited in claim 16, wherein the fluid delivery system comprises:
a solution source for providing the fluid solution; and
a product collector for receiving solution that has passed through the channel to produce product.

18. The apparatus, as recited in claim 17, wherein the first insulating layer has a thickness of less than 100 Å.

19. The apparatus, as recited in claim 18, wherein the first insulating layer does permits double layer charging of at least 1 μC/cm² before dielectric breakdown under the reaction and voltage conditions.

20. The apparatus, as recited in claim 19, further comprising an electrical insulator forming sidewalls of the channel.

21. (canceled)
